(19) United States
(12) Patent Application Publication
(10) Pub. No.: US 2025/0137648 A1
(43) Pub. Date: May 1, 2025

(54) DECORATIVE PROJECTION SCREEN ASSEMBLY AND ELECTRIC FIREPLACE COMPRISING THE SAME

(71) Applicant: Source Pro Industries Ltd., Kowloon Bay (HK)

(72) Inventors: Jackey Chu, Kowloon Bay (HK); Charles Lam, Kowloon Bay (HK)

(73) Assignee: Source Pro Industries Ltd., Kowloon Bay (HK)

(21) Appl. No.: 18/493,858

(22) Filed: Oct. 25, 2023

(51) Int. Cl. F24C 7/00; G03B 21/62

(52) U.S. Cl. CPC F24C 7/004; G03B 21/62

(57) ABSTRACT

The present disclosure relates to a decorative projection screen assembly and an electric fireplace comprising the same. The decorative projection screen assembly comprises a projection screen and an ornamental assembly arranged in front of the projection screen, wherein the projection screen comprises a translucent portion and a transparent portion, the ornamental assembly comprises a translucent ornament, the translucent portion of the projection screen projects a flame light, the transparent portion of the projection screen allows for the flame light to go through the projection screen and be projected into the translucent ornament.

### TECHNICAL FIELD

The present disclosure generally relates to a decorative projection screen assembly and an electric fireplace comprising the same.

### BACKGROUND

In most currently available electric fireplaces, a flame generator, ornaments and either an opaque or translucent projection screen are assembled to provide a more realistic flame effect. Typically, there are two kinds of arrangements about the flame generator:
(a) a flame generator is embedded in the ornamental portion of the fireplace typically including simulated fire grate, logs, embers etc, which projects the light back towards an opaque screen to create a flame effect. In such type embodiments, lights can be angled to also project a portion of the flame lighting onto the logs or other decorative objects to create layers of flame projections typically referred to as a 3D flame. For example as shown in U.S. Pat. No. 10,883,722B2; or
(b) a flame generator is located at the back of a translucent projection screen which hides the components from the user, for example as shown in US20060026894A1. In such embodiments, the ornamental portion is located in front of the projection screen and therefore the flame effect light cannot be directly angled onto the logs due to their location.

In construction (a), the embedding of these components will negatively affect the aesthetics and realism of the ornaments which they are embedded within, as the size of the flame reflectors, spindle motor and light source must be accounted for in the shape of the ornaments which generally results in a over-sized uniform look which is unrealistic and aesthetically unappealing.

In construction (b), the current construction does not allow for a 3D flame effect. Also, the projection screen needs to be translucent material which has limitations to what materials can be used because the screen can't use real materials for cladding such as stone or brick on the back panel. These translucent projection screens also tend to use non-rigid type materials which cannot be independently mounted into modular type assemblies.

In both constructions, the projection screen and the ornamental portion typically including simulated fire grate, logs, embers etc. are separate parts which are separately illuminated and not combined into a single part. Also, the projection screen is typically made with non-rigid type materials, which is not suitable to provide support for other parts such as the heater assembly, flame generator assembly or decorative ornaments such as grate and logs.

### SUMMARY

An objective of the present disclosure is to design a decorative projection screen assembly and an electric fireplace comprising the same, in which brick or stone cladding shapes could be formed, painted or printed with translucent materials to create a realistic faux cladding on a projection screen which can still project light, which allows to focus light into an ornamental portion and a projection screen portion simultaneously thus creating a 3D flame effect and providing significant cost reductions.

Another objective of the present disclosure is to design a decorative projection screen assembly in which a projection screen and an ornamental assembly are combined or formed into a single part.

The third objective is to create structural mounting for the projection screen assembly which is typically made with non-rigid type materials. Further, the support member could also be used to mount the other components such as the heater assembly, flame generator assembly and decorative ornaments.

In particular, the present disclosure relates to a decorative projection screen assembly, comprising a projection screen and an ornamental assembly arranged in front of the projection screen, wherein the projection screen comprises a translucent portion and a transparent portion, the ornamental assembly comprises a translucent ornament, the translucent portion of the projection screen projects a flame light, the transparent portion of the projection screen allows for the flame light to go through the projection screen and be projected into the translucent ornament. Such a decorative projection screen assembly allows for the flame light to be projected in unison inside the ornament and screen simultaneously which creates a type of layered 3D effect.

In certain embodiments, the translucent portion of the projection screen could be printed or painted with translucent ink or coated with stone-like or brick-like patterns; the transparent portion of the projection screen could be an opening portion provided at a lower portion of the projection screen, and the ornamental assembly could be provided in front of the opening portion.

Further, the decorative projection screen assembly could comprise a support member, wherein the projection screen could be disposed on the support member; the support member could be with a cut-out or open area or a transparent substrate to allow the flame light to go through; the translucent ornament could have a cavity and an opening portion which is arranged correspondingly to the opening portion on the projection screen.

In certain embodiments, at least a portion of the ornamental assembly could be formed or mounted on the projection screen to form a single translucent part wherein a portion of the ornamental assembly could be integrally molded with the projection screen or attached to the projection screen to form an integral structure, and another portion of the ornamental assembly could be disposed in front of the projection screen; further comprising a supporting bracket, wherein the another portion of the ornamental assembly could be arranged on the supporting bracket.

The present disclosure also relates to an electric fireplace, comprising a decorative projection screen assembly as defined above and a cabinet.

In certain embodiments, a holder could be provided in the cabinet, the projection screen could be pluggable engaged with the holder; especially two holders could be correspondingly arranged at both sides of the projection screen, a slot could be provided on each of the holders, the two sides of the projection screen could be pluggable arranged in the slots.

Further, the decorative projection screen assembly comprises a flame generator assembly, wherein the flame generator assembly could be located at the rear of the projection screen. The flame generator assembly could be mounted to the decorative projection screen assembly or the projection screen. Especially, the flame generator assembly could include a flame generator, a rotary electric reflector and an inclined surface facing the projection screen, the rotary electric reflector includes a rotating shaft and some reflecting blades, the reflecting blades are arranged around the rotating shaft at intervals. The heater assembly could be mounted at the top of the supporting member.

### BRIEF DESCRIPTION OF THE DRAWINGS

These and other features, aspects, and advantages of the present invention will become better understood with reference to the following description, appended claims, and accompanying drawings, in which similar reference characters refer to similar parts, and in which:

FIG. 1 shows a decorative projection screen assembly according to the present disclosure, which includes a support member and a projection screen;

FIG. 2 shows an exploded view of the decorative projection screen assembly according to the present disclosure;

FIG. 3 shows a schematic view of installing the decorative projection screen assembly according to the present disclosure into a cabinet;

FIG. 4 shows a decorative projection screen assembly with an opening portion according to the present disclosure;

FIG. 5 shows a schematic view of combining the decorative projection screen assembly shown in FIG. 4 and an ornamental assembly;

FIG. 6 shows an exploded view of the structure shown in FIG. 5;

FIG. 7 shows an exploded view in which the projection screen and the ornamental assembly are formed as a single part;

FIG. 8 shows a schematic view of installing the decorative projection screen assembly shown in FIG. 7 into a cabinet;

FIG. 9 shows a working schematic view of an electric fireplace with the decorative projection screen according to the present disclosure;

FIG. 10 shows a sectional view of an electric fireplace with the decorative projection screen according to the present disclosure;

FIG. 11 shows a schematic view of an ornamental assembly 43 in which a portion of the ornaments are attached or formed to the projection screen;

FIG. 12 shows a sectional view of an electric fireplace with the decorative projection screen shown in FIG. 11;

FIG. 13 shows a decorative projection screen assembly without an opening portion according to the present disclosure;

FIG. 14 shows a sectional view of an electric fireplace with the decorative projection screen shown in FIG. 13;

FIG. 15 shows a decorative projection screen assembly with a flame generator assembly attached to the support member;

FIG. 16 shows a support member with a flame generator assembly attached;

FIG. 17 shows another embodiment of a decorative projection screen assembly according to the present disclosure;

FIG. 18 shows a back view of yet another embodiment of a decorative projection screen assembly according to the present disclosure;

FIG. 19 shows a portion of the decorative projection screen assemble shown in FIG. 18;

FIG. 20 shows yet another embodiment of a decorative projection screen assembly according to the present disclosure;

FIG. 21 shows a combined decorative projection screen assembly as shown in FIG. 20;

FIG. 22 shows a decorative projection screen assembly, in which a heating assembly is mounted to the decorative projection screen assembly;

FIG. 23 shows a back view of the decorative projection screen assembly as shown in FIG. 22;

FIG. 24 shows an exploded view of an electric fireplace with the decorative projection screen as shown in FIG. 22;

FIG. 25 shows a combined view of the electric fireplace as shown in FIG. 24.

### DETAILED DESCRIPTION

In order to make the objectives, technical solutions and advantages of the present disclosure clearer, the embodiments of the present disclosure will be described below in detail with reference to the accompanying drawings. The technical features in different embodiments of the present disclosure may be combined with each other if not conflicted. More particularly, it enables greater flexibility to the consumer for the overall design, as well as offering various cost and product development efficiencies. For example, numerous options for different components can be incorporated together in any desired manner to provide various alternatives for the consumer in terms of the overall size, shape, design and aesthetic appearance.

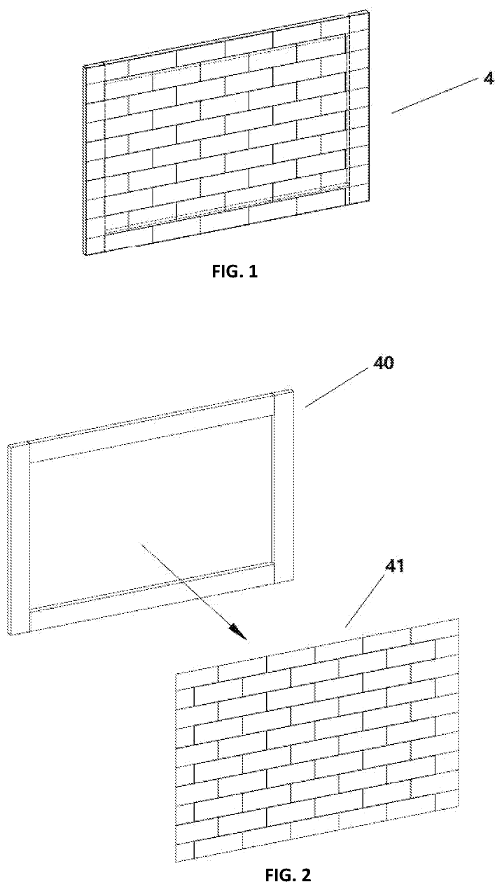

As shown in FIGS. 1-2, a decorative projection screen assembly 4 according to the present disclosure includes a support member 40 and a projection screen 41. An opening is formed on the projection screen 41, and the projection screen 41 is disposed on the support member 40. The support member 40 acts as a structural member to provide supporting and mounting to the projection screen 41 which can be a support frame with a cut-out or open area to allow the flame light to go through or a transparent substrate which is preferably rigid.

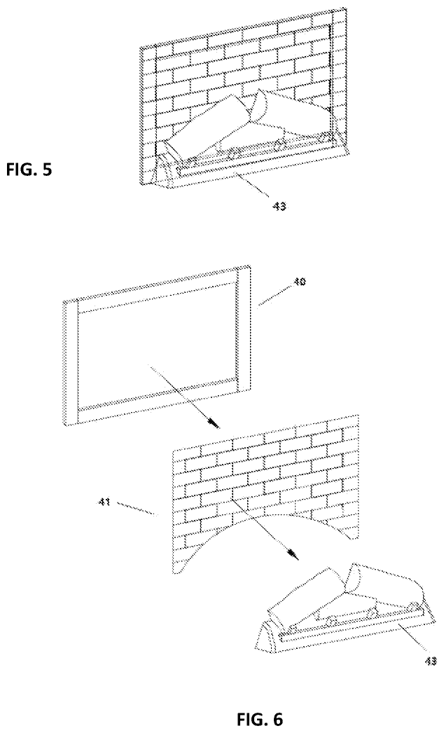

As shown in FIGS. 1-16, the support member 40 may be transparent or translucent, or even opaque to block light in certain unwanted areas. The projection screen 41 of the present disclosure is formed with a decorative pattern by for example printing with translucent ink, but allows light to pass through, so the projection screen 41 is a translucent screen. The decorative pattern shown in the figures is in a shape of brick, and those skilled in the art are aware that any other required decorative patterns such as stone-like pattern may also be used. In the present disclosure, the patterns could be formed by cladding process, preferably with an additional painting or silk-screening process to improve realistic finishing to the ornaments.

More particularly, the translucent material can be pre-printed with translucent ink in natural stone-like colors prior to forming and then may use a secondary painted or silk-screened process to add more refined color details or opaque areas to block the light in those areas, such as grouted lines or a burnt halo. For some versions of the projection screen that are formed with the ornaments as a single part, an additional paint coating or silk-screening over the ornaments will be added to improve the realism to the ornamental portion.

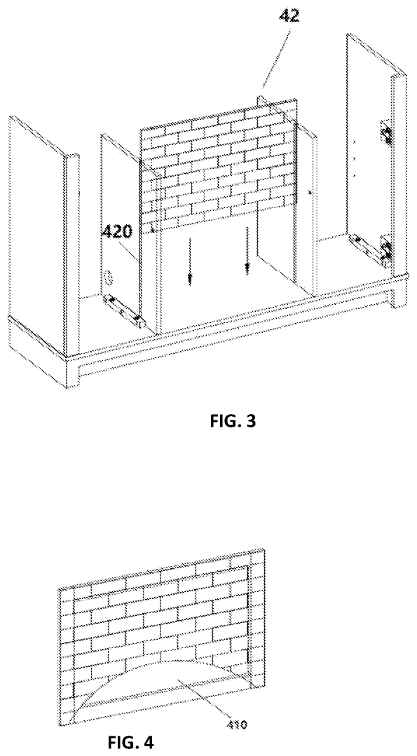

As shown in FIG. 3, two sides of the decorative projection screen assembly 4 may be mounted to two holders 42. Specifically, the holders 42 and the two sides of the decorative projection screen assembly 4 may be engaged. For example, each holder 42 can be provided with a slot, which is compatible with one side of the decorative display assembly 4. When installing, both sides of the decorative projection screen assembly 4 may be inserted into the slots 420 of the holders 42, and the holders 42 may be fixed on the base of the fireplace, thus enabling quick installation and secure fixation.

As shown in FIGS. 4-6, a lower portion of the projection screen 41 may also be provided with an opening portion 410, and an ornamental assembly 43 is provided in front of the opening portion 410. By disposing the opening portion 410, the light illuminated from the rear of the projection screen 41 simultaneously illuminates directly on the ornamental assembly 43. It is also possible to set the ornamental assembly 43 in front of the translucent projection screen 41 shown in FIGS. 1-2. At this circumstance, the light illuminated from the rear of the projection screen needs to pass through the translucent projection screen 41 to reach the ornamental assembly 43, so that the illumination effect on the ornamental assembly 43 is weaker. It should be noted that the shape of the opening portion 410 in FIG. 4 may be changed to adapt to different requirements. The ornamental assembly 43 could include ornamental objects such as a grate, logs and an ember bed, preferably with an additional painted or silk-screen process to add details such as grout lines and texturing details.

In the above embodiments, the projection screen 41 and the ornamental assembly 43 are separated components, which are manufactured and installed separately. It will not only make the assembling process complex, but also increase the cost of molding and manufacturing. In certain embodiments, vacuum forming or injection can be used to create a projection screen with ornaments as a single part. In other type embodiments, ornamental parts with light openings can be pre-mounted onto the projection screen to form an integral structure.

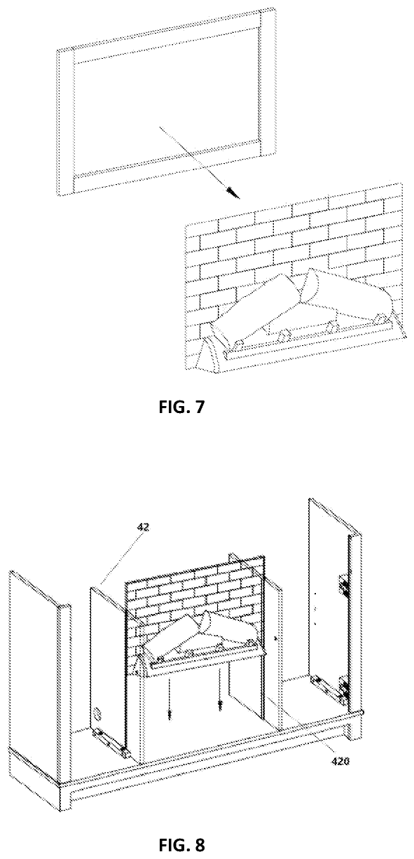

For example, in the embodiment shown in FIGS. 7-8, the projection screen 41 and the ornamental assembly 43 may also be vacuumed or injected to form as a single part, in which the ornamental assembly 43 is formed on the projection screen 41. Such an integral structure can simplify the assembling process and reduce the cost for manufacturing. The projection screen 41 and the ornamental assembly 43 with a single part can be installed directly into the slots 420 of the holders 42, which can be installed easily and fast. Further, in this embodiment, the cabinet may not be provided with a base panel for supporting the ornamental assembly.

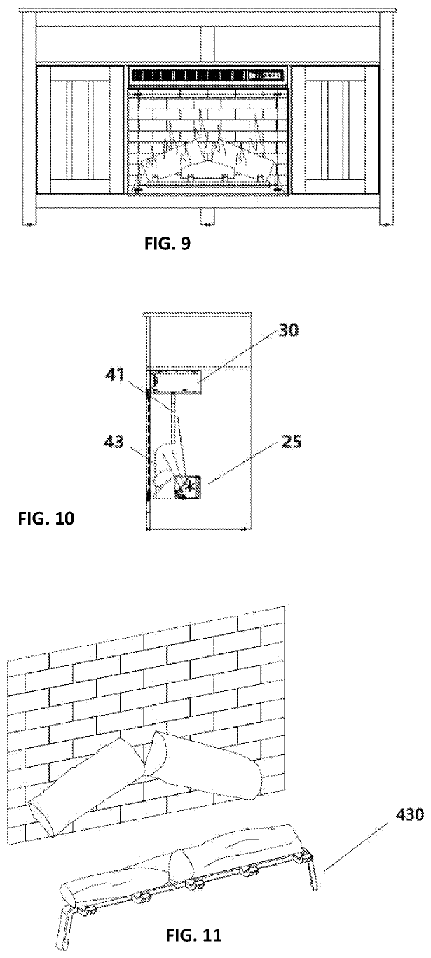

FIGS. 9-10 show an embodiment of the decorative projection screen assembly of the present disclosure applied to an electric fireplace. As shown, the electric fireplace includes a cabinet, a decorative projection screen assembly 4 and a heating assembly 30. The decorative display component 4 and the heating assembly 30 are installed in the cabinet, and the heating assembly 30 can heat the air and blow it out from the front side. Heating assembly 30 may be arranged adjacent to the decorative projection screen assembly 4 in a vertical direction. The electric fireplace also provides a flame generator assembly 25, and the flame generator assembly 25 is located at the rear of the decorative projection screen assembly 4. A portion of the light emitted by the flame generator assembly 25 directly illuminates on the projection screen 41, and another portion of the light directly illuminates on the ornamental assembly 43 through the opening portion 410 on the projection screen 41. Since the projection screen 41 is formed with a translucent decorative pattern and the ornamental assembly 43 arranged on front of the projection screen 41 also has a decorative effect, so that a highly realistic 3D effect can be simulated in the electric fireplace.

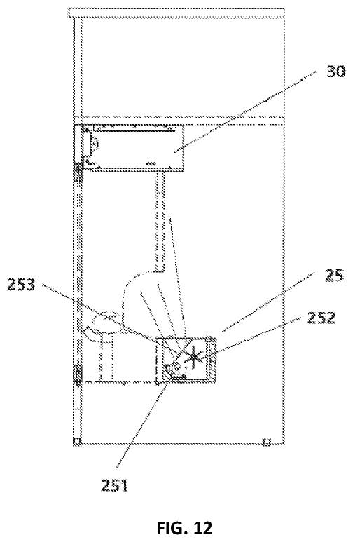

In the embodiment shown in FIGS. 11-12, a portion of the ornamental assembly 43 may be integrally molded with the projection screen 41 or attached to the projection screen 41 to form an integral structure, and another portion of the ornamental assembly 43 is disposed in front of the projection screen 41. In one modified embodiment, another portion of the ornamental assembly 43 may also have a supporting bracket 430 to increase the height of the ornamental assembly 43.

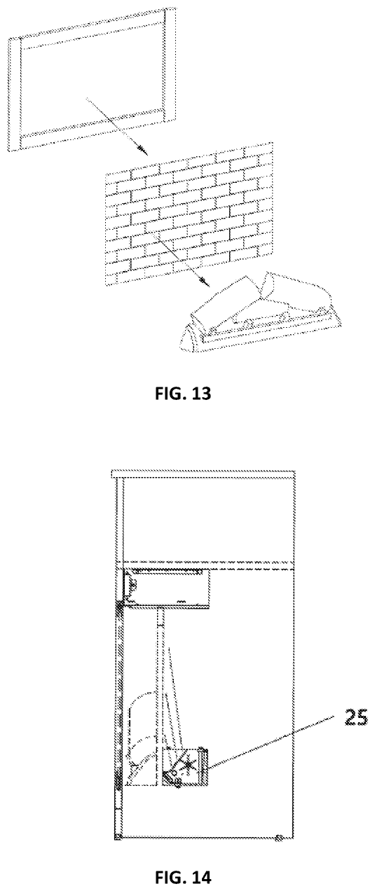

FIGS. 13-14 show another embodiment of the projection screen 41, which is not provided with an opening portion 410 as shown in FIG. 2. In this embodiment, the light from the back of the projection screen will not illuminate directly on the ornamental assembly, but will firstly pass through the translucent projection screen.

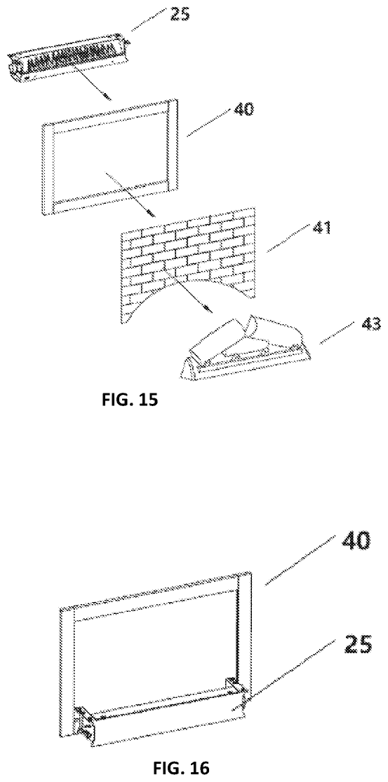

As shown in FIGS. 15-16, a schematic view of a flame generator assembly 25 which is mounted to the decorative projection screen assembly 4 is shown. As shown, the flame generator assembly 25 may be mounted to the rear of the support member 40, for example by tightening bolts and the like. Also, the flame generator assembly 25 may be mounted to the projection screen 41.

Typically, as shown in FIG. 12, the flame generator assembly 25 could include a flame generator 251 and a rotary electric reflector 252. The flame generator 251 is capable of emitting different colors of light, and can use different color combinations of bulbs or light strips. Rotary electric reflector 252 includes a rotating shaft and some reflecting blades, the reflecting blades are arranged around the rotating shaft at intervals. The rotating shaft can automatically rotate under the drive of the power supply, thus driving the reflecting blades to rotate. The light emitted by the flame generator 251 is reflected by the rotating reflecting blades, and illuminates onto the inclined surface 253, with the flame pattern on the inclined surface 253, creating a flame burning effect, and displayed on the projection screen 41.

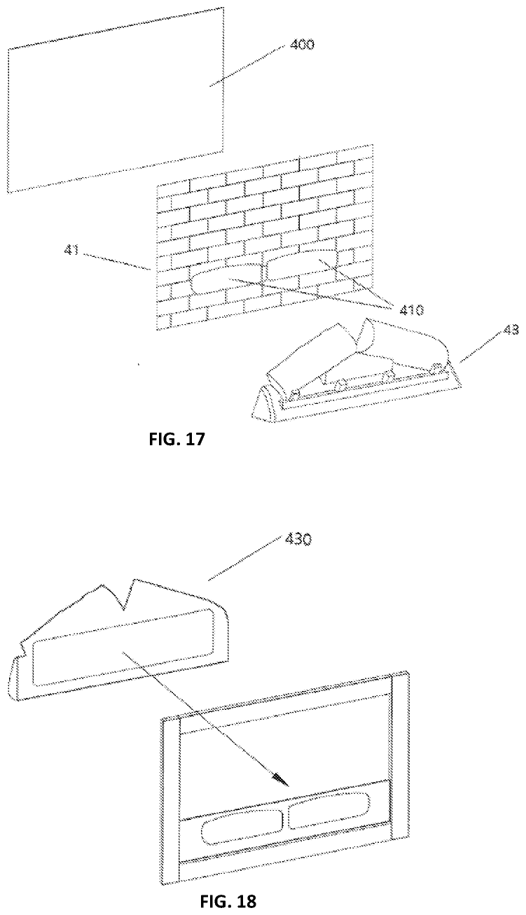

As shown in FIG. 17, the support member 40 can further be a transparent substrate 400 which is preferably rigid, and the projection screen 41 can further be a printed translucent screen with at least one opening 410, which has a number of two as shown in FIG. 17. The projection screen 41 is attached onto the transparent substrate 400 using an adhesive or similar method. The transparent portions allow for the flame effect to go through. A translucent ornament of the ornamental assembly 43 is placed in front of the transparent openings.

It is also possible that the printed brick could also be printed or painted directly onto the transparent substrate 400 with translucent ink or paint. A portion could then be left un-painted or un-printed to remain completely transparent as an opening, which would eliminate the need for an additional layer.

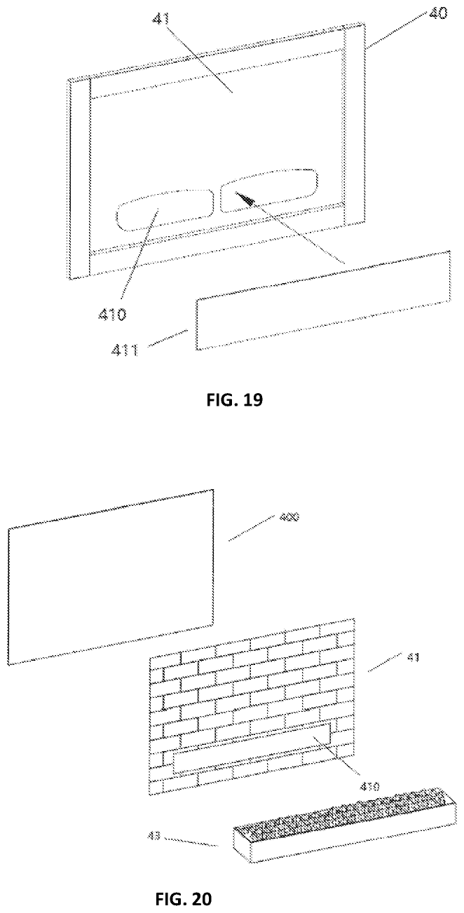

As shown in FIGS. 18-19, a printed translucent projection screen with an opening 410 is mounted onto a support member 40. The transparent portion of the opening allows for the flame effect to go through, and a rigid transparent panel 411 can also be added to where the opening is situated to add rigidity to the opening area. Also, the number of the opening 410 could be two or more. A translucent ornament 430 of the ornamental assembly 43 is placed in front of the transparent portion, and the translucent ornament 430 also has a cavity and an opening portion which is arranged correspondingly to the opening 410 on the projection screen.

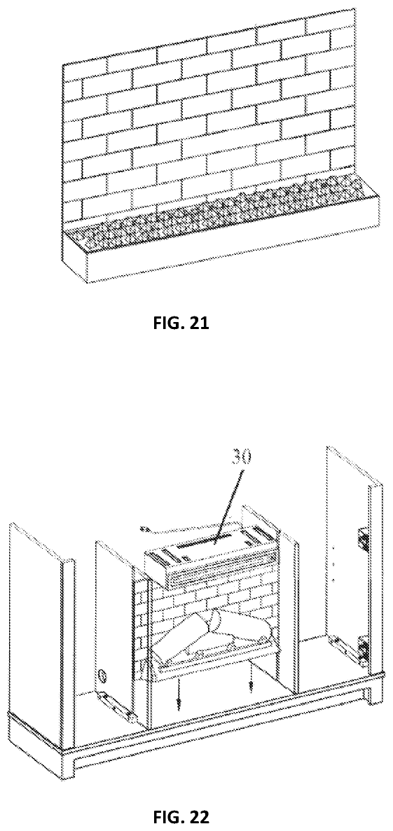

FIGS. 20-21 show yet another embodiment of a decorative projection screen assembly, in which a crystal module acts as the ornamental assembly 43. The crystal module may include a support base, a plurality of crystals which are placed on the support base, and also a cavity to receive the flame light illuminated from the back side. There is an opening 410 provided on the projection screen 41, which opening has a shape corresponding to the crystal module. The projection screen 41 is attached onto a transparent substrate 400 which is preferably rigid. The crystal module is also provided with an opening at the back side to allow for the flame effect to go through.

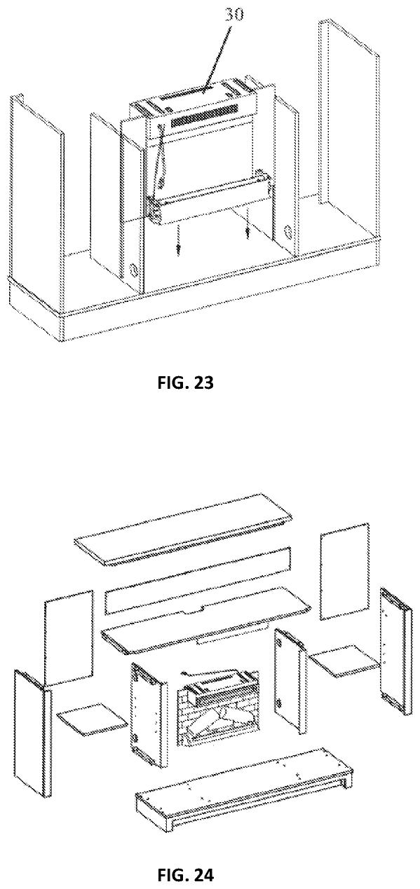

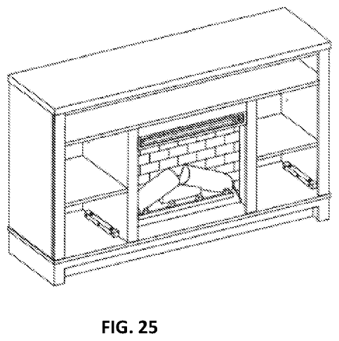

FIGS. 22-23 show yet another embodiment of a decorative projection screen assembly, in which a heating assembly 30 is mounted to the decorative projection screen assembly, preferably is mounted to the projection screen or the support member of the projection screen. Additionally, the heating assembly 30 could be connected to the flame generator 251 by a connector, which could make it possible to connect the heating assembly to the flame generator before being assembled to the cabinet if using the holders for mounting. In particularly, the connector could connect an AC heater to a DC flame generator. FIGS. 24-25 show an electric fireplace with the decorative projection screen as shown in FIGS. 22-23.

Although the implementations of the present disclosure are described above, the contents descried are only implementations used to understand the present disclosure and not intended to limit the present disclosure. Without departing from the spirit and scope disclosed by the present disclosure, any person skilled in the art to which the application belongs can make any modifications and alterations to the forms and details of implementation. However, the protection scope of the present disclosure shall still be subject to the scope defined by the appended claims.

What is claimed is:

1. A decorative projection screen assembly, comprising a projection screen and an ornamental assembly arranged in front of the projection screen,
wherein the projection screen comprises a translucent portion and a transparent portion, the ornamental assembly comprises a translucent ornament, the translucent portion of the projection screen projects a flame light, the transparent portion of the projection screen allows for the flame light to go through the projection screen and be projected into the translucent ornament.

2. The decorative projection screen assembly according to claim 1, wherein the translucent portion of the projection screen is printed or painted with translucent ink or coated with stone-like or brick-like patterns.

3. The decorative projection screen assembly according to claim 1, wherein the transparent portion of the projection screen is an opening portion provided at a lower portion of the projection screen, and the ornamental assembly is provided in front of the opening portion.

4. The decorative projection screen assembly according to claim 3, further comprising a support member, wherein the projection screen is disposed on the support member.

5. The decorative projection screen assembly according to claim 4, wherein the support member is with a cut-out or open area or a transparent substrate to allow the flame light to go through.

6. The decorative projection screen assembly according to claim 3, wherein the translucent ornament has a cavity and an opening portion which is arranged correspondingly to the opening portion on the projection screen.

7. The decorative projection screen assembly according to claim 1, wherein at least a portion of the ornamental assembly is formed or mounted on the projection screen to form a single translucent part.

8. The decorative projection screen assembly according to claim 7, wherein a portion of the ornamental assembly is integrally molded with the projection screen or attached to the projection screen to form an integral structure, and another portion of the ornamental assembly is disposed in front of the projection screen.

9. The decorative projection screen assembly according to claim 8, further comprising a supporting bracket, wherein the another portion of the ornamental assembly is arranged on the supporting bracket.

10. An electric fireplace, comprising a decorative projection screen assembly according to claim 1 and a cabinet.

11. The electric fireplace according to claim 10, wherein a holder is provided in the cabinet, the projection screen is pluggable engaged with the holder.

12. The electric fireplace according to claim 10, wherein two holders are correspondingly arranged at both sides of the projection screen, a slot is provided on each of the holders, the two sides of the projection screen are pluggable arranged in the slots.

13. The electric fireplace according to claim 10, further comprising a flame generator assembly, wherein the flame generator assembly is located at the rear of the projection screen.

14. The electric fireplace according to claim 13, wherein the flame generator assembly is mounted to the decorative projection screen assembly, preferably is mounted to the projection screen.

15. The electric fireplace according to claim 13, wherein a heating assembly is mounted to the decorative projection screen assembly, preferably is mounted to the projection screen or a support member of the projection screen.

16. The electric fireplace according to claim 13, wherein the flame generator assembly includes a flame generator, a rotary electric reflector and an inclined surface facing the projection screen, the rotary electric reflector includes a rotating shaft and some reflecting blades, the reflecting blades are arranged around the rotating shaft at intervals.
